(19) United States
(12) Patent Application Publication
(10) Pub. No.: US 2007/0072594 A1
(43) Pub. Date: Mar. 29, 2007

(54) Method and apparatus for enhanced distributed indication of VoIP telephone calls

(76) Inventors: Rami Caspi, Sunnyvale, CA (US); William J. Beyda, Cupertino, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/232,473

(22) Filed: Sep. 21, 2005

(51) Int. Cl. H04M 3/42

(52) U.S. Cl. 455/415

(57) ABSTRACT

A telecommunications system includes a wireless network; a telephony client operably coupled to the network; and an indication device operably coupled to the network and configured to receive an audio file from the telephony client indicative of an incoming telephone call. In certain embodiments, the audio file comprises calling party identification information. In some embodiments, the system includes a calling party identification control unit and a text to speech engine, wherein said audio file comprises speech-converted calling party identification information.

### CROSS REFERENCE TO RELATED APPLICATIONS

The present application is related to commonly assigned, co-pending U.S. Patent Application Serial No. 2005P11988, titled METHOD AND APPARATUS FOR DISTRIBUTED INDICATION OF VoIP TELEPHONE CALLS, filed concurrently herewith.

### BACKGROUND OF THE INVENTION

1. Field of the Invention

The present invention relates to electronic appliances and, particularly, to a device for providing an indication of an incoming telephone call.

2. Description of the Related Art

Internet telephony, also known as voice over IP (VoIP) telephony, is becoming increasingly popular among residential customers. Service providers such as Vonage and LINGO offer attractive VoIP packages, which include local, long-distance, and international rates lower than those offered by the traditional telephone company providers. Typically, all that is required is a broadband Internet connection, such as a DSL link or cable modem service, and a standalone IP telephone or a PC running a software IP telephone client. A personal computer running a software IP telephone client is typically the most cost effective option, since the software usually is provided free as part of the VoIP package.

A disadvantage of the VoIP soft client is that it is typically installed on a single, usually desktop, computer in a single room such as a home office or bedroom that may be located remotely from a center of household activity. Consequently, the ringing indicative of an incoming call can often not be heard. A user could simply purchase several standalone VoIP telephones and distribute them about the house in much the same way as the typical plain old telephone service (POTS) customer does. However, this can be a relatively expensive undertaking.

As such, there is a need for an improved system and method for providing indication of incoming VoIP telephone calls. There is a further need for an inexpensive VoIP call notification system for use in conjunction with a VoIP soft client.

### SUMMARY OF THE INVENTION

These and other drawbacks in the prior art are overcome in large part by a system and method according to embodiments of the present invention.

A telecommunications system according to embodiments of the present invention includes a wireless network; a telephony client operably coupled to the network; and an indication device operably coupled to the network and configured to receive an audio file from the telephony client indicative of an incoming telephone call. In certain embodiments, the audio file comprises calling party identification information. In some embodiments, the system includes a calling party identification control unit and a text to speech engine, wherein said audio file comprises speech-converted calling party identification information.

A telecommunications device in accordance with embodiments of the present invention includes a voice over IP telephony client; a calling party identification unit; a text-to-speech conversion unit; and a wireless local area network interface; wherein said telecommunications device is configured to receive incoming calling party identification information using said calling party identification unit and convert said calling party identification information to speech using said text-to-speech conversion unit and transmit a corresponding audio file to an indication device via said wireless local area network interface. In certain embodiments, the device further includes means for generating a message having a field for insertion of said calling party identification information.

A telecommunications device in accordance with embodiments of the present invention includes a housing including a pronged plug for insertion into a standard electrical wall outlet; a controller mounted within said housing and including a wireless local area network controller configured to receive incoming call indicia from a voice over IP telephony client; and a speaker operably coupled to the controller and configured to provide audible incoming call announcements responsive to said incoming call indicia; wherein said incoming call indicia comprises an audio file transmitted from a voice over IP telephony client.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is perspective pictorial view of a typical installation of an indication system in accordance with embodiments of the present invention.

FIG. 2 is a diagram schematically illustrating a system according to embodiments of the present invention.

FIG. 3 is a block diagram illustrating an indication device according to embodiments of the present invention.

FIG. 4A and FIG. 4B illustrate exemplary indication devices according to embodiments of the present invention.

FIG. 5 is a flowchart illustrating operation of embodiments of the present invention.

FIG. 6 is a signaling diagram illustrating operation of an embodiment of the present invention.

FIG. 7A and FIG. 7B are flowcharts illustrating operation of embodiments of the present invention.

FIG. 8 is a flowchart illustrating operation of embodiments of the present invention.

FIG. 9 is a flowchart illustrating operation of embodiments of the present invention.

FIG. 10 is a flowchart illustrating operation of embodiments of the present invention.

FIG. 11 is a diagram illustrating exemplary announcement/incoming call indication messages for use in embodiments of the present invention.

FIG. 12 is a flowchart illustrating operation of embodiments of the present invention.

FIG. 13A, FIG. 13B, and FIG. 13C are flowcharts illustrating operation of embodiments of the present invention.

FIG. 14 is a diagram illustrating announcement/incoming call indication setup according to embodiments of the present invention.

FIG. 15 is a block diagram of an exemplary VoIP client device according to an embodiment of the present invention.

### DETAILED DESCRIPTION OF EMBODIMENTS OF THE INVENTION

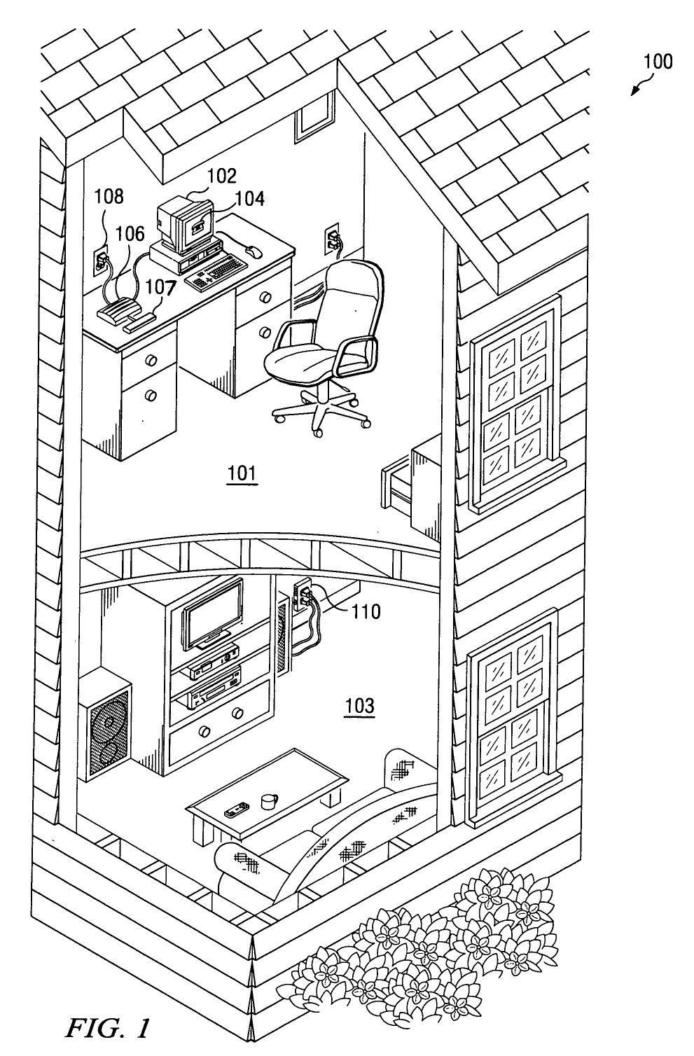

Turning now to the drawings and, with particular attention to FIG. 1, a diagram of a typical installation of an incoming telephone call indication system 100 according to embodiments of the present invention is shown.

In the example illustrated, a room 101, such as a home office, is equipped with a computer 102 implementing a voice over IP telephony client 104 according to embodiments of the present invention. A cable or DSL modem 106 couples to a cable or RJ-11 jack 107. Also coupled to the modem 106 is a wireless local area network router 108. Computer 102 and other network devices such as a printer (not shown) may be equipped with wireless LAN network interface cards for communicating via the router 108 over the network. The router and network interface cards may implement any of a variety of wireless network standards, such as IEEE 802.11b or 802.11g, although others are contemplated.

In a room 103, separate from room 101, a user may install an indication or alerting device 110 in accordance with embodiments of the present invention. As will be explained in greater detail below, an indication device 110 according to embodiments of the present invention may plug into a standard wall electrical outlet and may include a network interface as well as a speaker. The indication device 110 is configured to receive signals from the telephony application 104 indicating that an incoming call is present. The indication device 110 will then provide an audible indication or alerting to the incoming call. Thus, the user can, for example, be watching television in room 103 and yet hear the incoming call indication in room 103 and answer the call in room 101. In addition, the indication device 110 may be equipped with electrical receptacles so that the underlying outlet is still usable by other devices, such as a television.

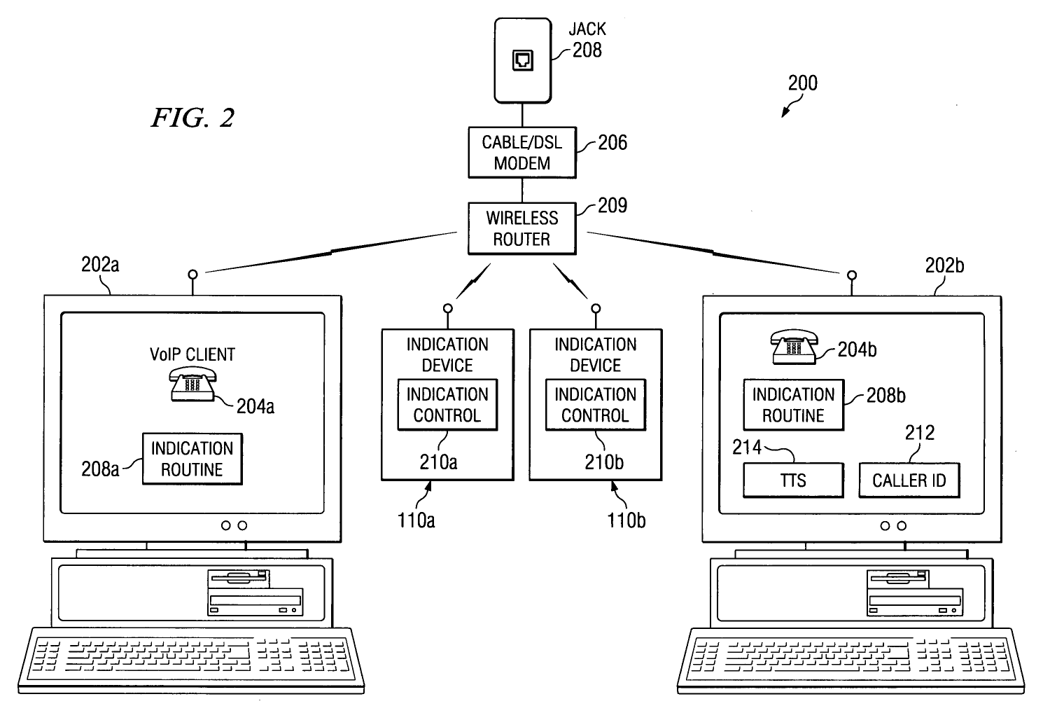

Turning now to FIG. 2, a diagram schematically illustrating embodiments of the present invention is shown. More particularly, as shown, the system 200 includes a cable or DSL modem 206 coupled to a jack 208, such as an RJ-11 jack. Typically the jack 208 is installed in a wall, and couples the modem 206 to the Internet, including an Internet service provider (ISP) and VoIP provider (not shown). The modem 206 couples to a wireless router or hub 209. Suitable wireless hubs are available from a variety of manufacturers. As noted above, suitable hubs can employ any of a variety of wireless standards, including IEEE 802.11b and 802.11g.

In the example illustrated, the wireless router 209 thus communicates with network devices such as computer 202a, computer 202b, and indication devices 110a, 110b. The network devices are provided with wireless network interfaces (not shown) for communicating via the wireless router (209); the wireless network interfaces may be internal or external to the various network devices.

The indication devices 110a, 110b may be equipped with indication controls 210a, 210b in accordance with embodiments of the present invention. As will be discussed in greater detail below, in certain embodiments, the indication devices are provided with a speaker for playing an incoming call indication or announcement tone. In other embodiments, the indication devices 110a, 110b may be configured to receive incoming call signaling indications and/or audio files for playing as incoming call indications.

The computers 202a, 202b may be equipped with VoIP telephony soft clients 204a, 204b, respectively. In addition to providing standard VoIP telephony functions, the VoIP soft clients 204a, 204b can provide indication signaling in accordance with embodiments of the present invention. In particular, the computers 202a, 202b may be equipped with indication routines 208a, 208b that cooperate with the telephony clients 204a, 204b in accordance with embodiments of the present invention.

In operation, a call can be received over the Internet and, in particular, at the modem 206 via the jack 208. The wireless router 209 can then route the call the appropriate computer or computers 202a, 202b. In particular, routing the call includes sending an incoming call notification to the appropriate VoIP client 204a, 204b. In response, the client can cause an audible ringing via the computer's speakers, and can also transmit incoming call signaling to the indication devices 110a, 110b.

In response, the indication devices 110a, 110b provide an audible incoming call indication. If the call is dropped or picked up, the telephony client 204a, 204b can send one or more commands to terminate the audible notification.

In certain embodiments, rather than playing a simple tone, the indication routines 208a, 208b can be used to send audio files to the indication devices, which can then be played to provide an incoming call notification.

In addition, in certain embodiments, a computer, such as computer 202b may additionally be equipped with a text-to-speech (TTS) engine 214 and a calling party identification (CPI) engine 212. As will be discussed in greater detail below, the indication routine 208b of such a computer may be configured to interact with the TTS engine 214 and the CPI engine 212 to provide audio indicia of calling party information to the indication device 210. The indication device 110a, 110b can then play the file to signal an incoming call.

That is, in certain embodiments, the user can configure the system to read the incoming calling party identification information, convert it to speech, save it as an audio file and transmit it to the indication device 110. Also, in certain embodiments, additional information can also be prerecorded, and the combined information and calling party identification information can be transmitted to the indication device.

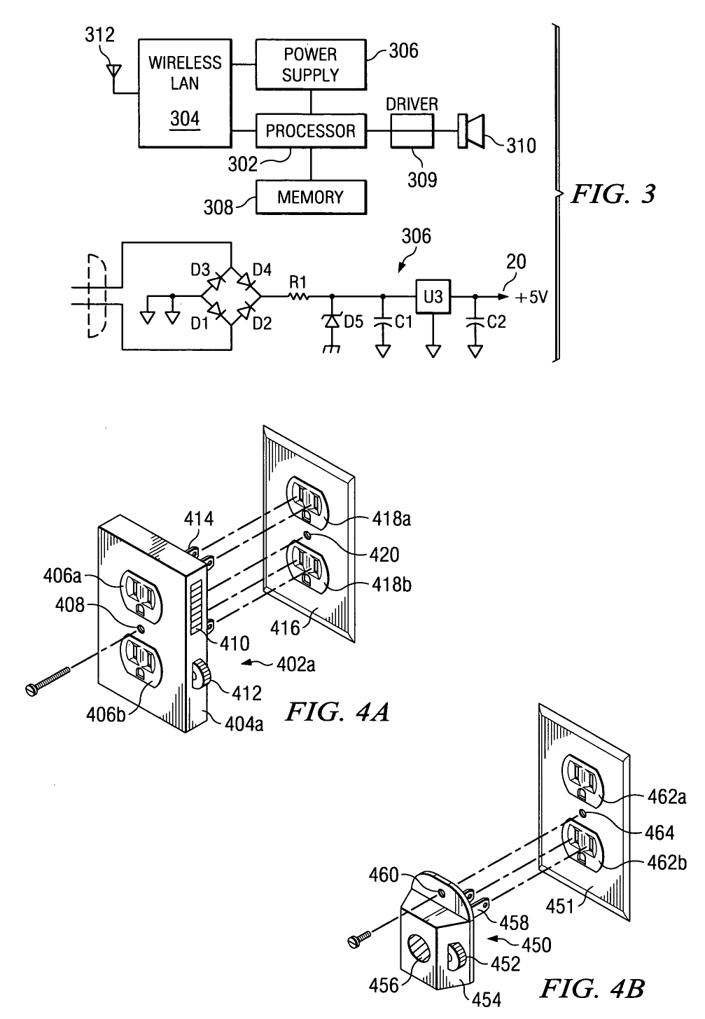

Turning now to FIG. 3, a diagram illustrating an exemplary indication device 110 is shown. As shown, the device includes a processor 302, memory 308, power supply 306, wireless LAN control 304, antenna 312, output driver 309 and speaker 310.

The wireless LAN interface 304 transmits and receives signals over the antenna 312 and performs any necessary filtering, modulation/demodulation, error correction, packetizing/depacketizing, etc. The processor 302, in cooperation with the interface 304, implements an indication control 210 (FIG. 2) and may be implemented as any suitable microprocessor, microcontroller, or combinations thereof and performs various control functions associated with operation of the invention. In particular, the processor 302 receives commands via the wireless LAN interface 304 to activate and deactivate the speaker 310, by way of sending appropriate control signals through driver 309. Memory 308 is accessible by processor 302 and may be used to store, for example, programs and/or data; in certain embodiments, this can include an audio file player and storage for audio files.

The power supply 306 provides the power to power the circuit. In particular, in the embodiment illustrated, the power supply 306 provides regulated 5 V DC as VCC on terminal 320 to power the circuit. The line voltage from the plug 319 is regulated by a full wave bridge (D1-D4) and then dropped by a resistor R1 and clamped by zener diode D5. This voltage is filtered by capacitor C1 and regulated at 5 V by regulator U1 to provide the circuit's 5 V DC power on terminal 230.

It is noted that, while in certain embodiments, the indication device draws power from a wall outlet, in other embodiments, the power supply may be a rechargeable or nonrechargeable battery. Thus, the figures are exemplary only.

Turning now to FIG. 4A and FIG. 4B, external views of indication devices constructed in accordance with embodiments of the present invention are shown. As can be appreciated, the indication device(s) can be placed in bedrooms, family rooms, recreation rooms, hallways, etc., wherever it is desired to receive an audible incoming telephone call indication.

Turning now to FIG. 4A, the indication device 402a may be constructed largely of plastic materials and, in particular, injection molded plastic materials. The indication device 402a includes a housing 404a which may include openings for a speaker 410, a control knob 412, sockets 406a, and prongs 414. In addition, various indicator LEDs (not shown) may be provided to display, for example, whether power is available and whether the network is connected.

As discussed above, the speaker provides an audible indication of the incoming call. The opening 410 may be covered with a grid or mesh, etc., to allow sound to be emitted. The control knob 412 may be used to set, for example, the volume of the audible incoming call announcement.

The indication device 402a also includes a plug 414a for insertion into outlet 418a and a plug 414b (not shown) obscured behind the housing for insertion into socket 418b. As discussed above, the indication device 402a can draw power from one of the sockets 418a, 418b. In addition, the indication device includes sockets 406a, 406b which cooperate electrically and mechanically with the prongs 414a and 414b for receiving the prongs of electrical cords associated with other appliances. Thus, the sockets 406a, 406b are used to “replace” sockets 418a, 418b, which are covered by the device housing. The device is thus easily installed and uninstalled simply by plugging it into a standard electrical wall outlet. In addition, if desired, the indication device 402a may include a hole 408 for receiving a screw which allows it to be more rigidly attached to the wall outlet via screw hole 420.

Turning now to FIG. 4B, a diagram of another embodiment of the present invention is shown. The indication device 450 of FIG. 4B has a housing 454, typically formed of plastic, that includes an opening for a dial 452 and a speaker 456. In addition, openings are provided for prongs 458 for insertion into socket 462b. Also, a hole 460 may be provided for receiving a screw for securing the indication device to the wall outlet screw hole 464. In this embodiment, only one set of prongs is provided; thus, only one socket 462a, 462b is obscured by the device; the other remains open.

It is noted that FIG. 4A and FIG. B are exemplary only. Indication devices may be provided that have more or fewer cooperative plugs and sockets. For example, an indication device may be provided that has only one external socket; others may be provided that have four external sockets. Still others may be provided that have plugs or prongs connected via an electrical cord rather than built into the housing. Such embodiments may also be provided with an arbitrary number of sockets, or none. Still others may have no sockets or plugs, especially those which are energized by battery rather than electrical outlet.

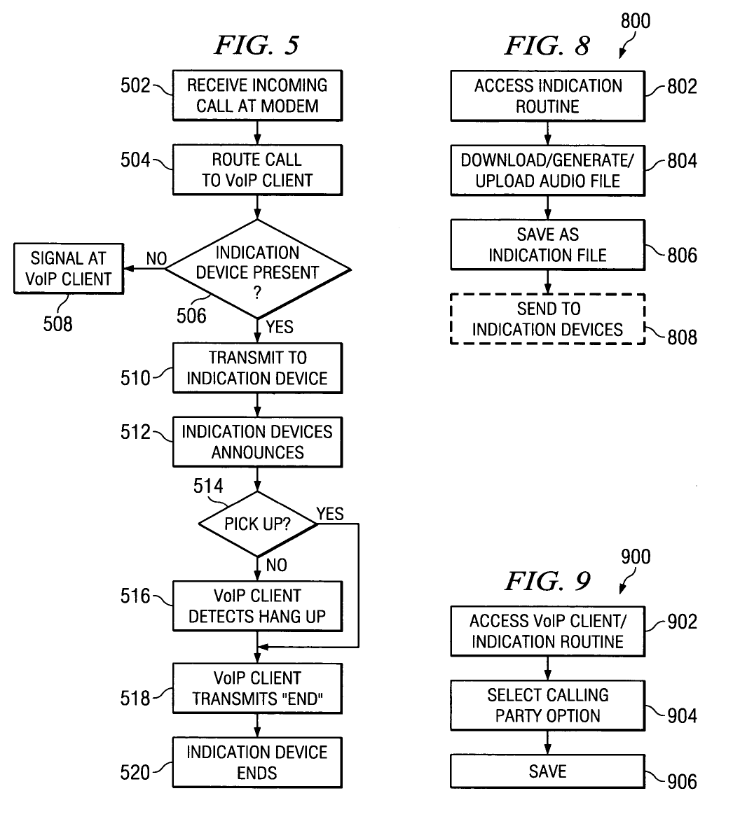

Turning now to FIG. 5, a flowchart 500 illustrating operation of an embodiment of the present invention is shown. The particular arrangement of elements in the flowchart 500 is not meant to imply a fixed order to the elements; embodiments can be practiced in any order that is practicable.

Initially, in a step 502, the modem 206 (FIG. 2) can receive an incoming call from the VoIP provider. In a step 504, the router 209 can route the call to the VoIP client 204a. In a step 506, the VoIP client 204a can determine if an indication device 110 is present. If no such device is present, the VoIP client 204a can cause the computer to provide an incoming call indication, at a step 508. For example, the computer can use its speaker (not shown) to sound a tone or chime to signal the incoming call.

If the indication device 110 is present, then in a step 510, the VoIP client's indication routine 208a transmits an incoming call notification to it and, in particular, to its indication control 210a. In response, in a step 512, the indication device's indication control 210a provides the audible incoming call announcement. In a step 514, the user can pick up. If he does not, then in a step 516, the VoIP client 204a can detect the caller hang up. In response, the VoIP client 204's indication routine 208a transmits an a termination or “end” signal to the indication device 110, in a step 518. In response, the indication device 110a will stop the announcement, in a step 520. Similarly, if the user does pick up, then the VoIP client 204 will transmit “end” (step 518).

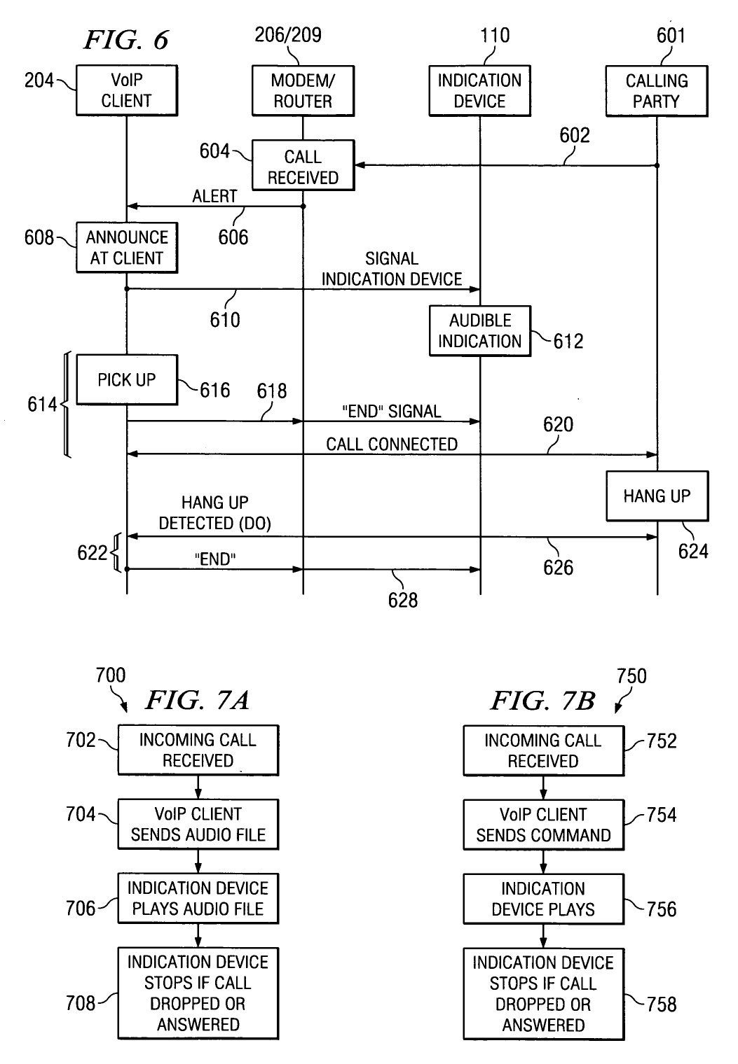

Turning now to FIG. 6, a diagram illustrating signaling for an embodiment of the present invention is shown. In the example illustrated, shown are a VoIP client 204, a modem/router 206/209 (shown as a common unit for sake of convenience), an indication device 110, and a calling party 601.

Initially, the calling party 601 can attempt to call the user at the VoIP client, at 602. The call is received, at 604, by the modem/router 206/209. The modem/router 206/209 sends an alert to the VoIP client 204, at 606. The VoIP client 204 announces the incoming call at the local computer, at 608. If the VoIP client 204 determines that an indication device is present, at 610, the VoIP client 204 can use its indication routine to signal the indication device 110 via the router 209. In response, at 612, the indication device 110 provides an audible indication of the incoming call.

Signaling if the VoIP client 204 picks up is shown at 614. At 616, the VoIP client 204 can pick up. At 618, the VoIP client 204's indication routine transmits an “end” signal to the indication device 110 via the router 209. The audible indication is terminated by the indication control, and the call is connected, at 620.

Signaling if the VoIP client 204 does not pick up is shown at 622. In particular, at 624, the caller can hang up. This may be detected at 626 by the VoIP client 204. If so, at 628, the VoIP client 204's indication routine signals “end” to the indication device 110, whose indication control 210 then shuts down the alerting.

As noted above, in certain embodiments of the present invention, an audio file may be transmitted from the client 204 to the indication device 110; the file can then be used at the indication device 110 to announce the incoming call. That is, the indication control 210 of the indication device 110 can include or be in communication with an audio file player and sufficient memory to store one or more audio files. Typically, the file is recorded or identified to the indication routine prior to telephone calls being received; the file can then be available to provide an incoming call notification. The file may be of any suitable format, such as MP3, WAV, etc.

Turning now to FIG. 7A, a flowchart 700 illustrating operation of an embodiment of the present invention is shown. The particular arrangement of elements in the flowchart 700 is not meant to imply a fixed order to the elements; embodiments can be practiced in any order that is practicable. In particular, flowchart 700 illustrates audio file transmission according to an embodiment of the present invention.

Initially, in a step 702, an incoming call can be received in a manner similar to that discussed above. In a step 704, the VoIP client 104 (or the indication routine 208) can send an audio file to the indication device. As noted above, the audio file can be a preconfigured and/or pre-recorded audio file stored in a convenient location. In a step 706, the indication device 110 receives the audio file and its indication control 210 plays the file to announce the incoming call. Then, in a step 708, the indication device 110 can stop playing the audio file if the call is dropped by the caller or answered by the called party in a manner similar to that discussed above.

Turning now to FIG. 7B, a flowchart 750 illustrating operation of an embodiment of the present invention is shown. The particular arrangement of elements in the flowchart 750 is not meant to imply a fixed order to the elements; embodiments can be practiced in any order that is practicable.

In particular, in the embodiment illustrated, the audio file has been “pre-stored” at the indication device 110, i.e., transmitted in response to a manual command. In a step 752, an incoming call is received. In response, in a step 752, the VoIP client (and, particularly, the indication routine 208) sends an incoming call or “play” audio file command to the indication device. In a step 756, the indication device 110's indication control 210 accesses and plays the appropriate audio file. Then, in a step 758, the indication device's indication control 210 can stop playing the audio file if the call is dropped by the caller or answered by the called party.

As noted above, the audio file can be configured beforehand. This is illustrated more particularly in flowchart 800 of FIG. 8. The particular arrangement of elements in the flowchart 800 is not meant to imply a fixed order to the elements; embodiments can be practiced in any order that is practicable.

In a step 802, the user can access the indication routine 208. In certain embodiments, the indication routine forms a part of, or is accessible via, the VoIP client routine 204. Typically, the indication routine 208 would be accessible as a graphical user interface. In a step 804, the user can generate or upload or download the desired audio file. For example, the audio file could be a predetermined tune. The user could, for example, speak into the computer's microphone and record the result. Similarly the audio file could be downloaded from an audio file sharing service, or uploaded from a CD track. In a step 806, the file can be selected and saved as an incoming call indication file. Finally, in a step 808, the file can be sent to the indication device 110, either directly in response to the incoming call, or beforehand.

According to certain embodiments of the present invention, calling party identification information may be received, converted to speech, and used as the basis for the indication device 110's audible incoming call announcement. For example, if the caller's telephone number is received, the TTS engine 214 (FIG. 2) can convert it so speech. The indication device 110 receives the resulting conversion as a speech file and then repeats the telephone number as the incoming call announcement.

Turning now to FIG. 9, a flowchart 900 illustrating operation of an embodiment of the present invention is shown. The particular arrangement of elements in the flowchart 900 is not meant to imply a fixed order to the elements; embodiments can be practiced in any order that is practicable. In particular, FIG. 9 illustrates a user configuring calling party identification information.

In a step 902, the user can access the VoIP client 204, which includes the indication routine 208. The indication routine 208 allows the user to select a variety of options regarding configuring the indication device 110. In a step 904, the user can select a caller ID option, including, for example, selection of the appropriate caller ID field he wishes to make use of. As noted above, this can include, for example, the telephone number or the actual identity of the caller, or both. Thus, for example, the indication routine can be used to select “Calling Party Number.” If the calling party is at 555-1212, then the indication device will “speak” “555-1212.” Finally, in a step 806, the user can save the configuration information.

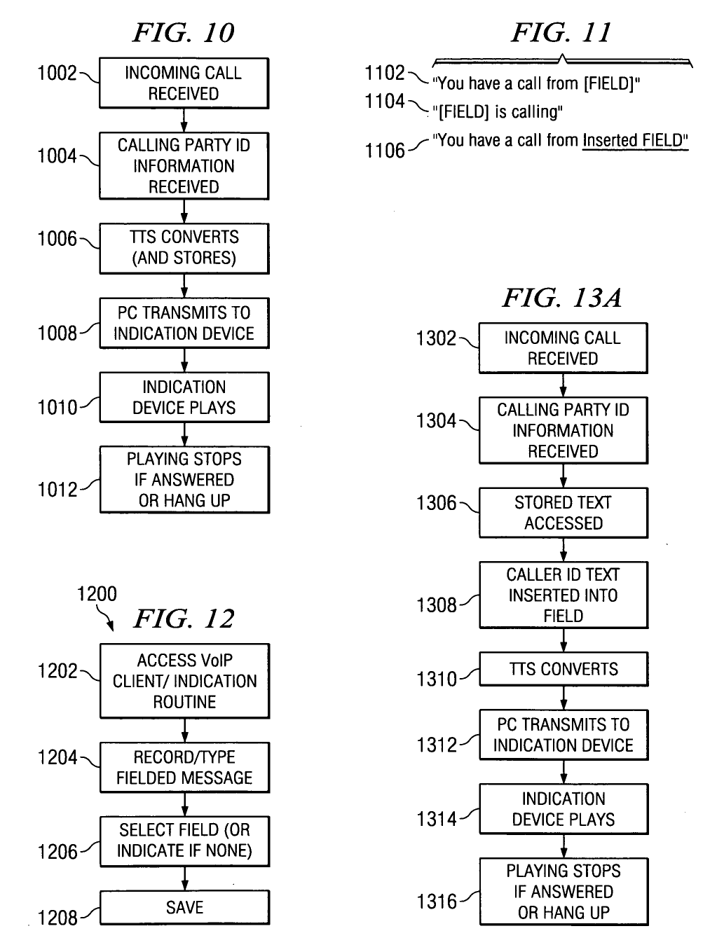

Turning now to FIG. 10, a flowchart 1000 illustrating operation of an embodiment of the present invention is shown. The particular arrangement of elements in the flowchart 1000 is not meant to imply a fixed order to the elements; embodiments can be practiced in any order that is practicable.

In particular, FIG. 10 illustrates handling of incoming calls for a system in which the calling party identification option has been selected. In a step 1002, an incoming call can be received. In a step 1004, the incoming calling party identification information can be received. Calling party identification information may be provided, for example, as a service from a telephone service provider. In a step 1006, the TTS engine 214 can convert the incoming calling party identification information to text, as selected in the configuration process discussed above. In a step 1008, the indication routine 208b can transmit the resulting audio calling party information as an audio file to the indication device 110. In a step 1010, the indication device 110b's indication control 210b plays the file. Finally, in a step 1012, the playing is stopped if the call is answered or the call is hung up.

The incoming calling party identification information may also be used in conjunction with other user provided information. For example, the calling party identification information can be inserted as a field into a text or audio message that has been pre-recorded by the user. The combined file is then transmitted as an audio file to the indication device.

Turning now to FIG. 11, a diagram illustrating exemplary messages and fields that may be used in conjunction with embodiments of the present invention is shown.

In particular, shown are exemplary messages 1102, 1104, and 1106. Message 1102 reads “You have a call from [FIELD],” where FIELD is the insertable calling party identification information. Similarly, message 1104 reads “[FIELD] is calling,” where FIELD is the insertable calling party identification information. As discussed above, typically, the message (other than the field) may be pre-recorded or pre-typed. When the calling party identification information arrives with the call, the FIELD can be inserted and the message speech-converted.

Message 1106 reads “You have a call from [inserted FIELD].” In this example, “inserted FIELD” may be pre-recorded or pre-typed along with the rest of the message. That is, a complete message is stored for each of a plurality of expected callers. Then, when the incoming call is received, along with its calling party information, a compare operation is performed. If there is a match between calling party information and an “inserted FIELD,” then the corresponding message is used as the indication message.

Turning now to FIG. 12, a flowchart 1200 illustrating operation of an embodiment of the present invention is shown. The particular arrangement of elements in the flowchart 1200 is not meant to imply a fixed order to the elements; embodiments can be practiced in any order that is practicable.

In particular, FIG. 12 illustrates FIELD setup according to an embodiment of the present invention. Initially, in a step 1202, the user can access the VoIP client or indication routine 208. In a step 1204, the user can speak or type in the personalized message. In a step 1206, the user can either select which calling party identification field information is to be inserted as the field, or can select no field. Finally, the user can save the configured information, in a step 1208. If not already in speech form, the message can then be TTS converted using the TTS engine.

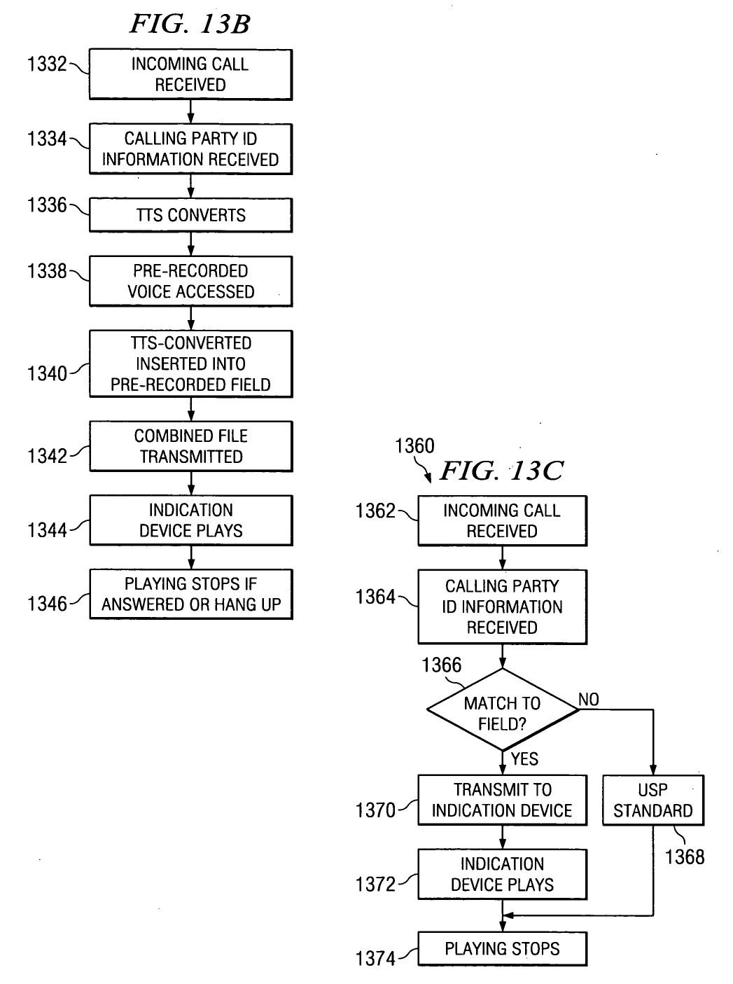

Turning now to FIG. 13A, a flowchart 1300 illustrating operation of an embodiment of the present invention is shown. The particular arrangement of elements in the flowchart 1300 is not meant to imply a fixed order to the elements; embodiments can be practiced in any order that is practicable.

Initially, in a step 1302, a call can be received at the VoIP client 204. At a step 1304, the calling party identification information can be received. In a step 1306, the stored text corresponding to an indication announcement message can be accessed by the indication routine 208. In a step 1308, the text calling party identification information can be inserted into the appropriate field in the accessed text. Next, in a step 1310, the text to speech engine 214 performs a speech conversion on the entire combined message. In a step 1312, the VoIP client's indication routine 208 transmits the audio file corresponding to the combined message to the indication device 110. The indication device 110 receives the audio file and plays it, in a step 1314. Finally, in a step 1316, playing will stop if the call is answered or the caller hangs up.

Turning now to FIG. 13B, a flowchart 1330 illustrating operation of an embodiment of the present invention is shown. The particular arrangement of elements in the flowchart 1330 is not meant to imply a fixed order to the elements; embodiments can be practiced in any order that is practicable.

Initially, in a step 1332, a call can be received at the VoIP client 204. At a step 1334, the calling party identification information can be received. In a step 1336, the text to speech engine 214 converts the text of the calling party identification information to speech. In a step 1338, the pre-recorded voice message is accessed. In a step 1340, the speech converted calling party identification information is inserted into the pre-recorded message FIELD. In a step 1342, the audio file corresponding to the combined message is transmitted to the indication device 110. The indication device 110 receives the audio file and plays it, in a step 1344. Finally, in a step 1346, playing will stop if the call is answered or the caller hangs up.

Turning now to FIG. 13C, a flowchart 1360 illustrating operation of an embodiment of the present invention is shown. The particular arrangement of elements in the flowchart 1360 is not meant to imply a fixed order to the elements; embodiments can be practiced in any order that is practicable.

Initially, in a step 1362, a call can be received at the VoIP client 204. At a step 1364, the calling party identification information can be received. At a step 1366, the system and, particularly, the indication routine 208, determines if the calling party information is a match to a field. That is, the indication routine 208 performs a search of stored messages and associated identifications. If there is not match, then a standard incoming call indicia can be used, in a step 1368. If there is a match to the field, then in a step 1370, the corresponding message is transmitted to the indication device 110. The indication device 110 receives the audio file and plays it, in a step 1372. Finally, in a step 1374, playing will stop if the call is answered or the caller hangs up.

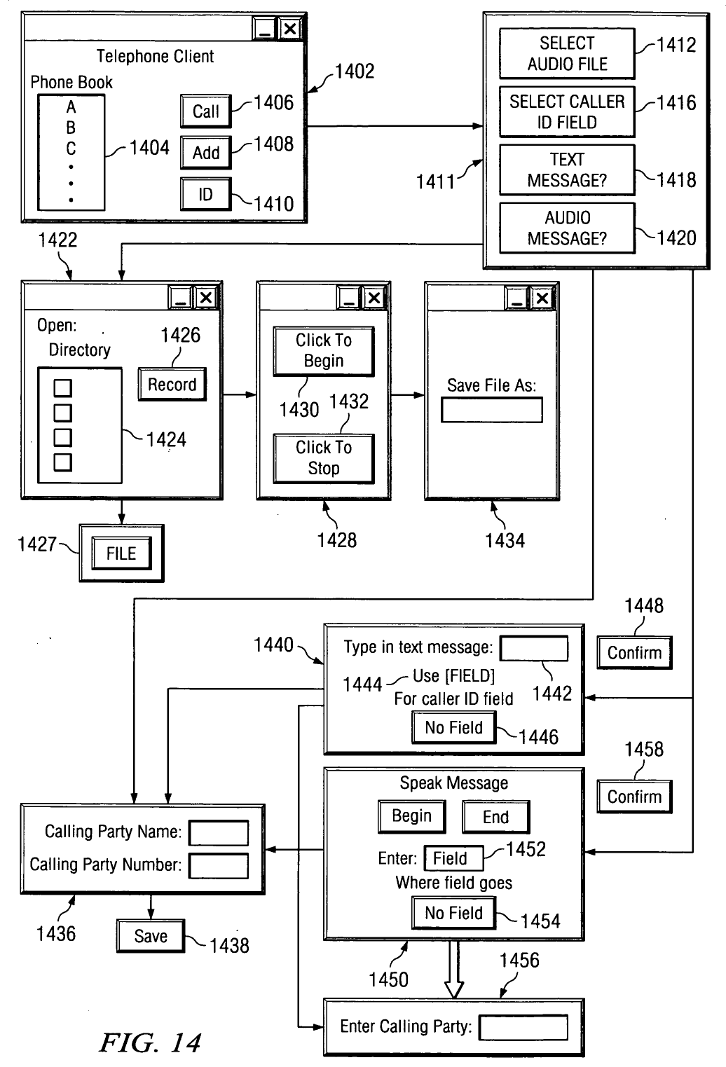

Turning now to FIG. 14, a diagram schematically illustrating indication message setup according to embodiments of the present invention is shown. In particular, shown is an exemplary graphical user interface that may be used in conjunction with the ToL client and indication routine.

Shown at window 1402 is an exemplary ToL client interface. The ToL client interface 1402 includes a phone book 1404, call activation control 1406, add to phone book control 1408, and add to indication device control 1410.

Selection of the add to indication device control 1410 causes a transition to window 1411. Window 1411 allows a user to select an audio file 1412, select a calling party identification field 1416, select or enter a text message 1418, and select or enter an audio message 1420.

If the user chooses “select audio file” 1412, then he is presented with window 1422. Window 1422 allows the user to open a file from a directory 1424 or select a “Record” option 1426. The directory 1424 may allow the user to browse the contents of his computer. If the user selects a file from the directory, then he may be asked to confirm the choice by dialog 1427. If the user elects to record a new message, then he is presented with dialog 1428, which allows him to click to begin 1430 and click to end 1432 the recording. Once completed, he can save the file under a preferred name, using dialog 1434.

If the user selected the Select Caller ID field control 1416, then he may be presented with a dialog 1436 to choose calling party number or calling party name, or both. He can save his choice using dialog 1438.

If the user chose to enter a text message 1418, then he may be presented with dialog window 1440. The window 1440 allow the user to type in the text message at 1442, and also select a control or enter FIELD where the field should go. Otherwise, the user can choose no field. If the user chooses no field, then he will be presented with dialog 1456, to enter the calling party number that should be compared. If the user chooses to enter a field, then he may be presented with a sequence of windows similar to 1436, 1438, allowing him to choose the calling party identification field for entry. He then may be allowed to confirm his choices with dialog 1448.

Similarly, if the user selects Audio Message at 1420, he may be presented with a dialog such as 1450. Window 1450 allows the user to speak the message in a manner similar to that described above with respect to window 1438 and elect to enter a field by clicking button 1452 where he expects the field to be entered. Otherwise he can elect no field 1454 and then enter the calling party number at 1456. Otherwise, he can enter the calling party information field using a dialog similar to 1436. He may then be given an option of confirming his selection(s) at 1458.

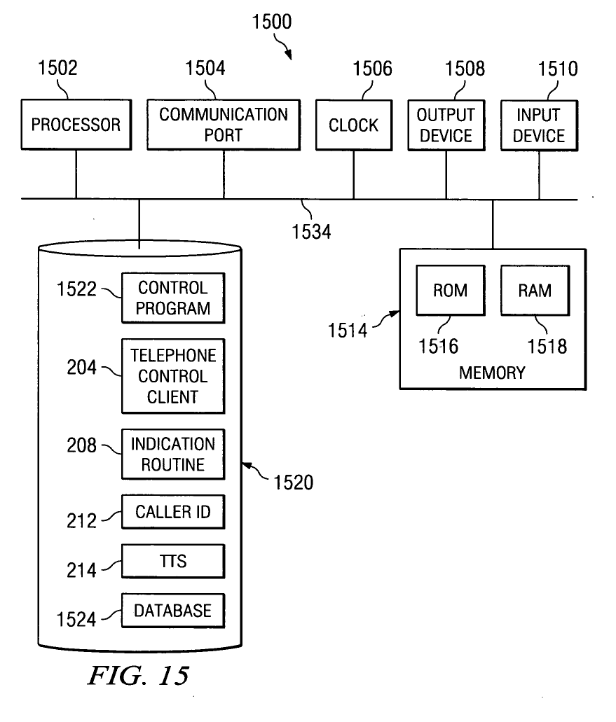

Now referring to FIG. 15, a representative block diagram of a computer or processing device 1500 suitable for use as a user device according to embodiments of the present invention is shown. In particular, the computer 1500 may be a device suitable for performing or accessing auto advance calling features in accordance with embodiments of the present invention. In some embodiments, the computer 1500 may include or operate a VoIP telephony application or client 204, an indication routine 208, a text-to-speech engine 214, a caller ID control 212, and database 1552. The computer 1500 may be embodied as a single device or computer, a networked set or group of devices or computers, a workstation, mainframe or host computer, etc. In some embodiments, the computer 1500 may implement one or more elements of the methods disclosed herein.

The computer 1500 may include a processor, microchip, central processing unit, or computer 1502 that is in communication with or otherwise uses or includes one or more communication ports or network interfaces 1504 for communicating with user devices and/or other devices. The communication ports 1504 may include such things as telephone adapters, local area network adapters, wireless communication devices, Bluetooth technology, etc. The computer 1500 also may include an internal clock element 1506 to maintain an accurate time and date for the computer 1500, create time stamps for communications received or sent by the computer 1500, etc.

If desired, the computer 1500 may include one or more output devices 1508 such as a printer, infrared or other transmitter, antenna, display screen or monitor, text to speech converter, speaker, etc., as well as one or more input devices 1510 such as a bar code reader or other optical scanner, infrared or other receiver, antenna, magnetic stripe reader, image scanner, roller ball, touch pad, joystick, touch screen, computer keyboard, computer mouse, microphone, etc.

In addition to the above, the computer 1500 may include a memory or data storage device 1520 to store information, software, databases, documents, communications, device drivers, etc. The memory or data storage device 1520 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc (CD), a DVD, and/or a hard disk. Thus, the storage device 1520 may include various combinations of moveable and fixed storage. The computer 1500 also may include memory 1514, such as ROM 1516 and RAM 1518.

The processor 1502 and the data storage device 1512 in the computer 1500 each may be, for example: (i) located entirely within a single computer or other computing device; or (ii) connected to each other by a remote communication medium, such as a serial port cable, telephone line or radio frequency transceiver. In one embodiment, the computer 1500 may be implemented as one or more computers that are connected to a remote server computer, as will be explained in greater detail below.

A conventional personal computer or workstation with sufficient memory and processing capability may be used as the computer 1500. The computer 1500 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1502. Other suitable processors may be available from Motorola, Inc., AMD, or Sun Microsystems, Inc. The processor 1502 also may be embodied as one or more microprocessors, computers, computer systems, etc.

Software may be resident and operating or operational on the computer 1500. The software may be stored on the data storage device 1512 and may include a telephony client or interface program 104.

The client control program 1522 may implement an operating system, such as Microsoft Windows. The telephony client 203 may implement a VoIP telephony application or may interface to a VoIP separate telephone. The indication routine 208 operates in conjunction with the VoIP control 204 in a manner discussed above. The TTS engine 214 functions to receive text and convert it to speech, in a manner similar to that discussed above. The caller identification control 212 receives calling party information. The databases 1552 may be used to store, e.g., audio files, text files and other indication device message files, and information that can be used to other purposes, such as the calling party identification operation described above. It is noted that, while illustrated as software stored in storage medium 1512, the various control modules in accordance with embodiments of the present invention may also include related firmware and/or hardware components. Thus, the figure is exemplary only.

The client control program 1522, telephony client 204, TTS engine 214, caller ID control 212 and indication control 208 may control the processor 1502. The processor 1502 may perform instructions of the control programs and clients, and thereby operate in accordance with the methods described in detail herein. The control programs and clients may be stored in a compressed, uncompiled and/or encrypted format. The control programs and clients furthermore include program elements that may be necessary, such as an operating system, a database management system and device drivers for allowing the processor 1502 to interface with peripheral devices, databases, etc. Appropriate program elements are known to those skilled in the art, and need not be described in detail herein.

According to some embodiments, the instructions of the control program and clients may be read into a main memory from another computer-readable medium, such as from the ROM 1516 to the RAM 1518. Execution of sequences of the instructions in the control program causes the processor 1502 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1502, communication ports 1504, clock 1506, output device 1508, input device 1515, data storage device 1512, ROM 1516 and RAM 1518 may communicate or be connected directly or indirectly in a variety of ways. For example, the processor 1502, communication ports 1504, clock 1506, output device 1508, input device 1515, data storage device 1512, ROM 1516 and RAM 1518 may be connected via a bus 1534.

While specific implementations and hardware/software configurations for the computer 1500 have been illustrated, it should be noted that other implementations and hardware configurations are possible and that no specific implementation or hardware/software configuration is needed. Thus, not all of the components illustrated in FIG. 15 may be needed for the computer 1500 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents.

What is claimed is:

1. A telecommunications device, comprising:
a housing including a pronged plug for insertion into a standard electrical wall outlet;
a controller mounted within said housing and including a wireless local area network controller configured to receive incoming call indicia from a voice over IP telephony client; and
a speaker operably coupled to the controller and configured to provide audible incoming call announcements responsive to said incoming call indicia;
wherein said incoming call indicia comprises an audio file transmitted from a voice over IP telephony client.

2. A telecommunications device in accordance with claim 1, said housing including a plug receptacle operably coupled to said pronged plug for receiving an appliance pronged plug, such that an attached appliance is energized via said standard electrical wall outlet.

3. A telecommunications device in accordance with claim 2, said housing further including a second pronged plug for insertion into a standard electrical wall outlet; and
a second plug receptacle operably coupled to said second pronged plug for receiving a second appliance pronged plug, such that an attached second appliance is energized via said standard electrical wall outlet.

4. A telecommunications device in accordance with claim 3, said housing having two dimensions substantially similar in size to those of a standard electrical outlet cover plate such that said housing can substantially fit over said standard electrical wall outlet.

5. A telecommunications system, comprising:
a wireless local area network;
a voice over IP telephony client operably coupled to said wireless local area network and configured to receive signaling indicative of an incoming telephone call; and
an alerting appliance operably coupled to the wireless local area network and located remotely from said voice over IP telephony client, the alerting appliance including a wireless local area network controller and configured to receive incoming telephone call signals from the voice over IP telephony client and provide audible indicia in response to said incoming telephone call signals;
wherein said audible indicia comprise playing an audio file received from said voice over IP telephony client.

6. A telecommunication system in accordance with claim 5, said alerting appliance having a housing including a pronged plug for insertion into a standard electrical wall outlet.

7. A telecommunications system in accordance with claim 6, said housing including a plug receptacle operably coupled to said pronged plug for receiving an appliance pronged plug, such that an attached appliance is energized via said standard electrical wall outlet.

8. A telecommunications system in accordance with claim 7, said housing further including a second pronged plug for insertion into a standard electrical wall outlet; and
a second plug receptacle operably coupled to said second pronged plug for receiving a second appliance pronged plug, such that an attached second appliance is energized via said standard electrical wall outlet.

9. A telecommunications system in accordance with claim 8, said housing having two dimensions substantially similar in size to those of a standard electrical outlet cover plate such that said housing can substantially fit over said standard electrical wall outlet.

10. A system, comprising:
a wireless local area network transmitter associated with a voice over IP client;
an alerting appliance including a wireless local area network receiver, the alerting appliance including a wireless local area network controller and configured to receive incoming telephone call signals from the voice over IP client and play an audio file in response to said incoming telephone call signals, said alerting appliance having a housing including a pronged plug for insertion into a standard electrical wall outlet.

11. A system in accordance with claim 10, said housing including a plug receptacle operably coupled to said pronged plug for receiving an appliance pronged plug, such that an attached appliance is energized via said standard electrical wall outlet.

12. A system in accordance with claim 11, said housing further including a second pronged plug for insertion into a standard electrical wall outlet; and
a second plug receptacle operably coupled to said second pronged plug for receiving a second appliance pronged plug, such that an attached second appliance is energized via said standard electrical wall outlet.

13. A system in accordance with claim 12, said housing having two dimensions substantially similar in size to those of a standard electrical outlet cover plate such that said housing can substantially fit over said standard electrical wall outlet.

14. A method, comprising:
receiving an incoming voice over IP telephone call at a voice over IP telephone client;
transmitting signaling indicative of said incoming voice over IP telephone call to a remote wireless local area network indication device; and
providing an audible indication at said indication device of said incoming voice over IP telephone call responsive to said signaling, said providing including playing an audio file at said indication device;
wherein said indication device includes
a housing including a pronged plug for insertion into a standard electrical wall outlet;
a controller mounted within said housing and including a wireless local area network controller configured to receive said signaling; and
a speaker operably coupled to the controller and configured to provide the audible indication.

15. A method in accordance with claim 14, further including:
transmitting a termination command to said indication device responsive to said call being picked up at said voice over IP telephone client; and
terminating said audible indication responsive to reception of said termination command.

16. A method in accordance with claim 14, further including:
transmitting a termination command to said indication device responsive to said call being dropped by a caller to said voice over IP telephone client; and
terminating said audible indication responsive to reception of said termination command.

17. A method, comprising:
mechanically and electrically engaging a wireless voice over IP telephony indication device in a standard electrical wall outlet;
receiving at said wireless voice over IP telephony indication device signaling indicative of an incoming telephone call; and
providing an audio file announcement of said incoming telephone call at said wireless voice over IP telephony indication device;
wherein said indication device includes:
a housing including a pronged plug for insertion into said standard electrical wall outlet;
a controller mounted within said housing and including a wireless local area network controller configured to receive said signaling; and
a speaker operably coupled to the controller and configured to provide the audible indication.

18. A method in accordance with claim 17, further including:
transmitting a termination command to said indication device responsive to said call being picked up at a voice over IP telephone client; and
terminating said audible indication responsive to reception of said termination command.

19. A method in accordance with claim 17, further including:
transmitting a termination command to said indication device responsive to said call being dropped by a caller to said voice over IP telephone client; and
terminating said audible indication responsive to reception of said termination command.

20. A device, comprising:
a housing for mechanically and electrically engaging a wireless voice over IP telephony indication device to a standard electrical wall outlet;
a controller mounted within said housing and including a wireless local area network controller configured to receive incoming call indicia from a voice over IP telephony client; and
an audio file player for playing an audio file responsive to reception of said incoming call indicia.

21. A device in accordance with claim 20, where said audio file is representative of calling party identification information.

22. A telecommunications system, comprising:
a wireless network;
a telephony client operably coupled to the network; and
an indication device operably coupled to the network and configured to receive an audio file from the telephony client indicative of an incoming telephone call.

23. A telecommunications system in accordance with claim 22, wherein said audio file comprises calling party identification information.

24. A telecommunications system in accordance with claim 22, further including a calling party identification control unit and a text to speech engine, wherein said audio file comprises speech-converted calling party identification information.

25. A telecommunications device, comprising:
a voice over IP telephony client;
a calling party identification unit;
a text-to-speech conversion unit; and
a wireless local area network interface;
wherein said telecommunications device is configured to receive incoming calling party identification information using said calling party identification unit and convert said calling party identification information to speech using said text-to-speech conversion unit and transmit a corresponding audio file to an indication device via said wireless local area network interface.

26. A telecommunications device in accordance with claim 25, further including means for generating a message having a field for insertion of said calling party identification information.

27. A telecommunications device in accordance with claim 26, wherein said generating means comprises means for composing a text message.

28. A telecommunications device in accordance with claim 26, wherein said generating means comprises means for composing an audio message.

29. A telecommunications device in accordance with claim 25, further comprising means for selecting a particular aspect of calling party identification information.
